(19) United States
(12) Patent Application Publication
(10) Pub. No.: US 2003/0212769 A1
(43) Pub. Date: Nov. 13, 2003

(54) Technical solution architect power distribution tool

(75) Inventors: Muhammad Ammar Chaudhry, Naperville, IL (US); Douglas Irvin Gerber, Palatine, IL (US); Kurtis Paul Longnecker, Plainfield, IL (US); Walter F. Schmidt, Darien, IL (US)

Correspondence Address: Rudolf. O Siegesmund, Suite 2000, 4627 N. Central Expressway, Dallas, TX, 75205-4017, US

(73) Assignee: International Business Machines Corporation, Armonk, NY

(21) Appl. No.: 10/142,605

(22) Filed: May 9, 2002

(51) Int. Cl. G06F 15/16

(52) U.S. Cl. 709/220; 709/223

(57) ABSTRACT

The present invention, Technical Solution Architect Power Distribution Tool (TSAPDT), permits users to configure networking devices in their enclosures. The user creates a list of enclosures to receive the devices. The user selects each enclosure and specifies the voltage and amperage of each electrical circuit providing power to the enclosure. The user then begins adding the networking devices, specifying the quantity of each device. The TSAPDT confirms that there is adequate space as well as electrical power and outlets. The TSAPDT indicates to the user if additional power circuits are required or if the physical space limitations of the enclosure are reached. When the user is satisfied that the solution is complete, the user may save the configuration to an electronic field and generate a report that also may be saved or electronically copied and pasted into another electronic document.

### FIELD OF THE INVENTION

The present invention relates generally to the field of software and specifically to a software program for a computer which determines the arrangement of networking devices and circuits within an enclosure.

### BACKGROUND OF THE INVENTION

Over the last few decades, computers have become an increasingly greater element in the way companies do business. Indeed, computer use has increased to the extent that many companies now have rooms or even buildings full of networking computers and related equipment. With the invention of the Internet, the demand for increased networking capacity has increased even further. These numerous computers, servers, routers, firewalls, switches, patch panels, and monitors are typically stored in a series of vertical racks, wherein the required equipment can slide into bays in the rack and be powered and connected as necessary.

One of the byproducts of the increased demand for computers and networking equipment is that new personnel positions are required that did not exist twenty years ago. One such position is that of the technical solution architect. One of the responsibilities of the technical solution architect is to configure and maintain the multitude of computer equipment required by companies for their networking requirements. In order to do this, the technical solution architect must carefully weigh the space and power requirements of each networking device and then determine the most effective way to configure the devices in the enclosures. In some instances, the technical solution architect may know the details of the devices to be installed and needs to know the number of enclosures and circuits required for each enclosure. These tasks are both challenging and time consuming. Therefore, a need exists for an apparatus that will allow the user to determine the most suitable arrangement of devices in an enclosure. Furthermore, a need exists for an apparatus that will inform the user of the number of required enclosures and circuits and the location of devices within those enclosures for a given list of devices.

### SUMMARY OF THE INVENTION

The present invention, a Technical Solution Architect Power Distribution Tool (TSAPDT), permits users to configure networking equipment consisting of a wide variety of popular networking devices including computers, servers, routers, firewalls, switches, patch panels, monitors, and the like in enclosures or racks. The TSAPDT manages available space and electrical power requirements and then reports the results automatically. The TSAPDT is a 32-bit windows-based software application that provides an intuitive user interface through which users may quickly and easily select the rack or enclosures required and then populate those containers with popular networking devices. After the user starts the software application, the user creates a list of enclosures to receive the networking devices. Next, the user selects each enclosure and specifies the voltage and amperage of each electrical circuit providing power to the enclosure. The user then begins adding the networking devices, specifying the quantity of each device. The invention reads the selections and presents them to the user in list format on one of the user interface screens. After a list of one or more devices is created, the user selects a button to add the list of devices to the selected enclosure. As the user adds devices to each enclosure in their solution, the present invention confirms that there is adequate space as well as electrical power and outlets. If a networking device is electrically provisioned so as to support redundant power sources, the tool properly associates the new device with electrical power sources in a redundant manner. Next, the TSAPDT recalculates the remaining free space and available power within the enclosure. The TSAPDT permits users to simultaneously configure many enclosures while maintaining critical information for each enclosure individually. While processing continues on the list, the tool indicates to the user if additional power circuits are required or if the physical space limitations of the enclosure are reached. At this point processing stops so that the user can either add more power circuits or select another enclosure into which the remaining devices should be added. When the user is satisfied that their solution is complete, they may save the configuration to an electronic field and generate a report that also may be saved or electronically copied and pasted into another electronic document. At any time during the design process, a user may request an itemized list of the devices and the physical and electrical characteristics. This report will also summarize the space and power usage for each enclosure.

The TSAPDT provides an enormous value to the technical solution architect community. The technical solution architects find that the TSAPDT dramatically reduces the amount of time and effort that was previously required to draft a solution manually without the TSAPDT. In some cases, a technical solution architect might have spent eight or more hours to process the equipment selections and calculations manually that are now done in a few minutes.

### BRIEF DESCRIPTION OF THE DRAWINGS

FIG. 1 is an illustration of a distributed data network.

FIG. 2 is an illustration of a data processing system.

FIG. 3 is an illustration of a data processing system.

FIG. 4A is an illustration of the enclosure information screen before the devices have been specified.

FIG. 4B is an illustration of the enclosure specification screen.

FIG. 4C is an illustration of the circuit specification screen.

FIG. 5A is an illustration of the component information screen.

FIG. 5B is an illustration of the device specification screen as accessed from the component information screen.

FIG. 6A is an illustration of the enclosure information screen after the devices have been specified.

FIG. 6B is an illustration of the device specification screen as accessed from the enclosure information screen.

FIG. 7 is an illustration of the component arrangement screen.

FIG. 8A is an illustration of the report screen.

FIG. 8B is an illustration of a sample report produced by TSAPDT.

FIG. 8C is an illustration of an enclosure configured according to the report in FIG. 8B.

FIGS. 9A and 9B are a flowchart of the logic behind TSAPDT.

### DETAILED DESCRIPTION OF THE PREFERRED EMBODIMENT

As used herein, the term “enclosure” means a mounting rack, either vertical or horizontal, which is used to store devices during their normal operation. The height of enclosures is measured in rack units. The terms “enclosure” and “rack” are used interchangeably. As used herein, the term “RU” is an abbreviation for rack unit and is the standard unit of measurement within a networking device enclosure. One RU is equal to 1.75 inches. As used herein, the term “device” means any computer component, networking component, web hosting component, server, router, firewall, switch, patch panel, monitor, or any other piece of equipment which is stored in an enclosure. As used herein, the term “circuit” means an electrical connection similar to a circuit breaker which is used in an enclosure to power devices. Each circuit generally has a power strip containing eight three-prong electrical outlets which are used for powering the devices within the enclosure. Each circuit is connected to a PDU and it is possible to have a plurality of circuits within a single enclosure. As used herein, the term “PDU” is an abbreviation for power distribution unit and means the power source which is used to transfer power to the circuits. A single PDU can be used to deliver power to a plurality of circuits. As used herein, the term “source enclosure” means an enclosure which contains a device. As used herein, the term “target enclosure” means an enclosure in which the user desires a device to be placed. The user will normally desire to move a device from source enclosure to a target enclosure.

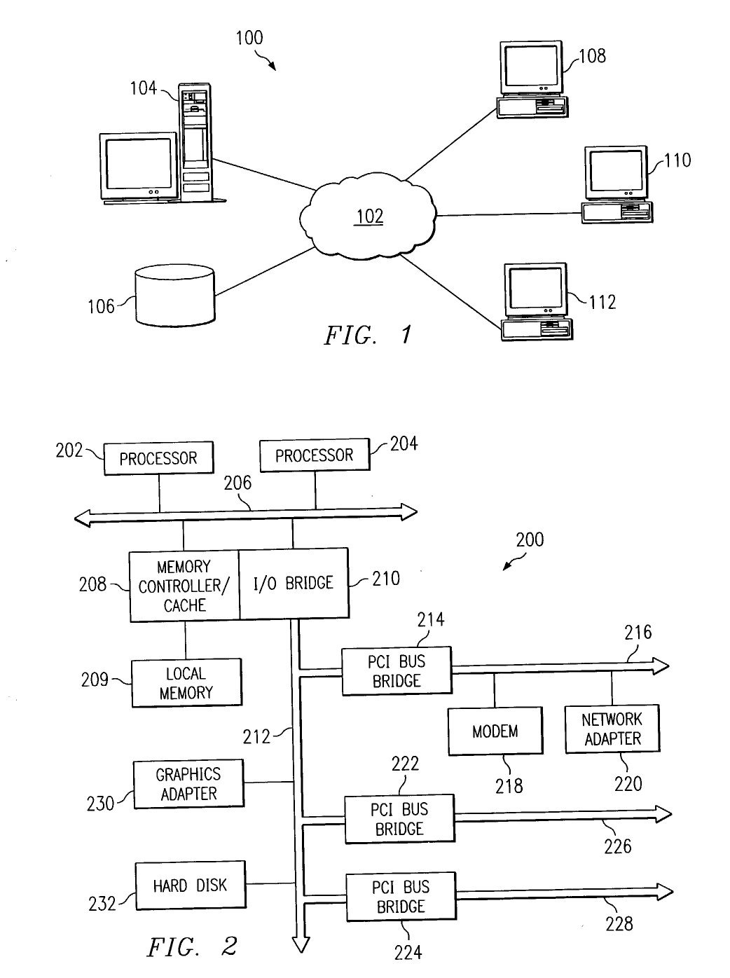

FIG. 1 depicts a pictorial representation of a distributed data processing system in which the present invention may be implemented and is intended as an example, and not as an architectural limitation, for the processes of the present invention. Distributed data processing system 100 is a network of computers which contains a network 102, which is the medium used to provide communication links between the various devices and computers connected together within distributed data processing system 100. Network 102 may include permanent connections, such as wire or fiber optic cables, or temporary connections made through telephone connections. In the depicted example, a server 104 is connected to network 102 along with storage unit 106. In addition, clients 108, 110, and 112 also are connected to a network 102. Clients 108, 110, and 112 may be, for example, personal computers or network computers.

For purposes of this application, a network computer is any computer, coupled to a network, which receives a program or other application from another computer coupled to the network. In the depicted example, server 104 provides Web based applications to clients 108, 110, and 112. Clients 108, 110, and 112 are clients to server 104. Distributed data processing system 100 may include additional servers, clients, and other devices not shown. In the depicted example, distributed data processing system 100 is the Internet with network 102 representing a worldwide collection of networks and gateways that use the TCP/IP suite of protocols to communicate with one another. Distributed data processing system 100 may also be implemented as a number of different types of networks, such as, an intranet, a local area network (LAN), or a wide area network (WAN).

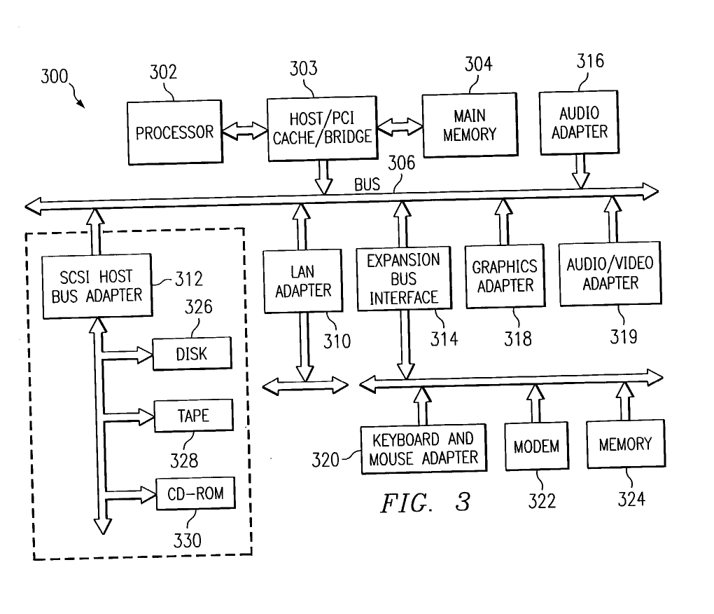

Referring to FIG. 2, a block diagram depicts a data processing system, which may be implemented as a server, such as server 104 in FIG. 1 in accordance with the present invention. Data processing system 200 may be a symmetric multiprocessor (SMP) system including a plurality of processors such as first processor 202 and second processor 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to 1/0 bus 212. Memory controller/cache 208 and I/O bus bridge 210 may be integrated as depicted. Peripheral component interconnect (PCI) bus bridge 214 connected to I/O bus 212 provides an interface to first PCI local bus 216. Modem 218 may be connected to first PCI local bus 216. Typical PCI bus implementations will support four PCI expansion slots or add-in connectors. Communications links to clients 108, 110 and 112 in FIG. 1 may be provided through modem 218 and network adapter 220 connected to first PCI local bus 216 through add-in boards. Additional PCI bus bridges such as second PCI bus bridge 222 and third PCI bus bridge 224 provide interfaces for additional PCI local buses such as second PCI local bus 226 and third PCI local bus 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly. Those of ordinary skill in the art will appreciate that the hardware depicted in FIG. 2 may vary. For example, other peripheral devices, such as an optical disk drive and the like also may be used in addition or in place of the hardware depicted. The depicted example is not meant to imply architectural limitations with respect to the present invention. The data processing system depicted in FIG. 2 may be, for example, an IBM RISC/System 6000 system, a product of International Business Machines Corporation in Armonk, N.Y., running the Advanced Interactive Executive (AIX) operating system.

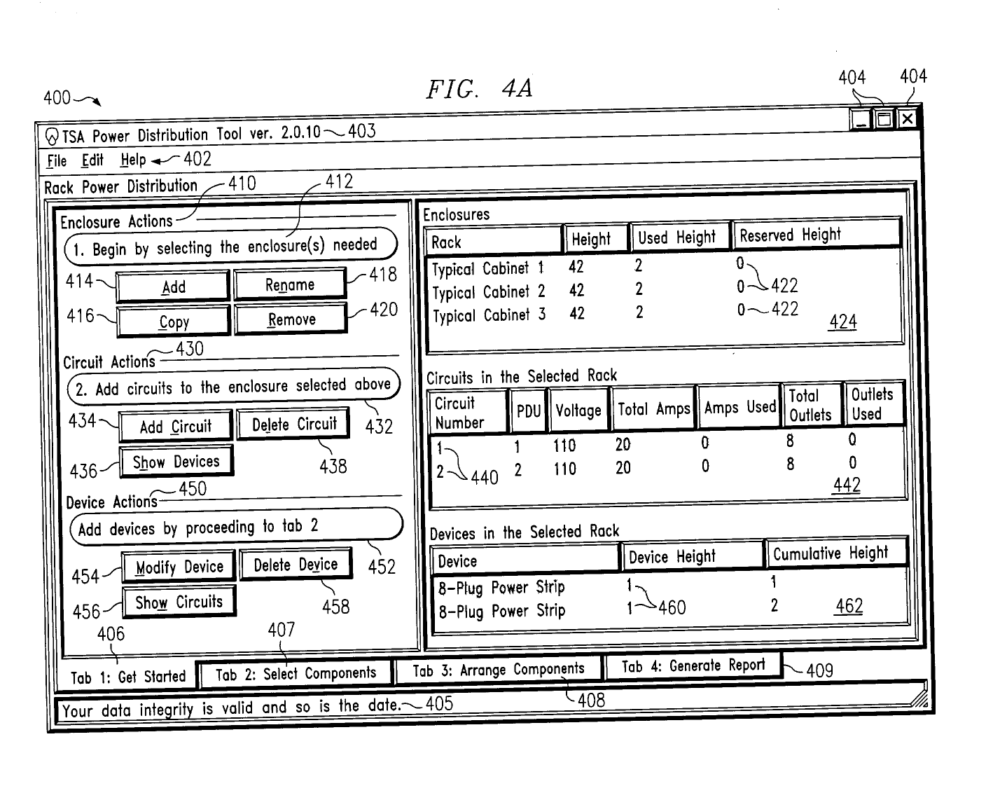

With reference now to FIG. 3, a block diagram illustrates a data processing system in which the invention may be implemented. Data processing system 300 is an example of either a stand-alone computer, if not connected to distributed data processing system 100, or a client computer, if connected to distributed data processing system 100. Data processing system 300 employs a peripheral component interconnect (PCI) local bus architecture. Although the depicted example employs a PCI bus, other bus architectures such as Micro Channel and ISA may be used. Processor 302 and main memory 304 are connected to PCI local bus 306 through PCI bridge 303. PCI bridge 303 also may include an integrated memory controller and cache memory for Processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM 330 in the depicted example. Typical PCI local bus implementations will support three or four PCI expansion slots or add-in connectors. An operating system runs on processor 302 and is used to coordinate and provide control of various components within data processing system 300 in FIG. 3. The operating system may be a commercially available operating system such as OS/2, which is available from International Business Machines Corporation. “OS/2” is a trademark of International Business Machines Corporation. An object oriented programming system, such as Java, may run in conjunction with the operating system and provides calls to the operating system from Java programs or applications executing on data processing system 300. “Java” is a trademark of Sun Microsystems, Incorporated. Instructions for the operating system, the object-oriented operating system, and applications or programs may be located on storage devices, such as hard disk drive 326, and they may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system. For example, data processing system 300, if configured as a network computer, may not include SCSI host bus adapter 312, hard disk drive 326, tape drive 328, and CD-ROM 330, as noted by the box with the dotted line in FIG. 3 denoting optional inclusion. In that case, the computer, to be properly called a client computer, must include some type of network communication interface, such as LAN adapter 310, modem 322, or the like. As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device which is configured with ROM and/or flash ROM in order to provide non-volatile memory for storing operating system files and/or user-generated data. The depicted example in FIG. 3 and above-described examples are not meant to imply architectural limitations with respect to the present invention. It is important to note that while the present invention has been described in the context of a fully functioning data processing system, those of ordinary skill in the art will appreciate that the processes of the present invention are capable of being distributed in a form of a computer readable medium of instructions and a variety of forms and that the present invention applies equally regardless of the particular type of signal bearing media actually used to carry out the distribution. Examples of computer readable media include recordable-type media, such a floppy disc, a hard disk drive, a RAM, and CD-ROMs, and transmission-type media, such as digital and analog communications links.

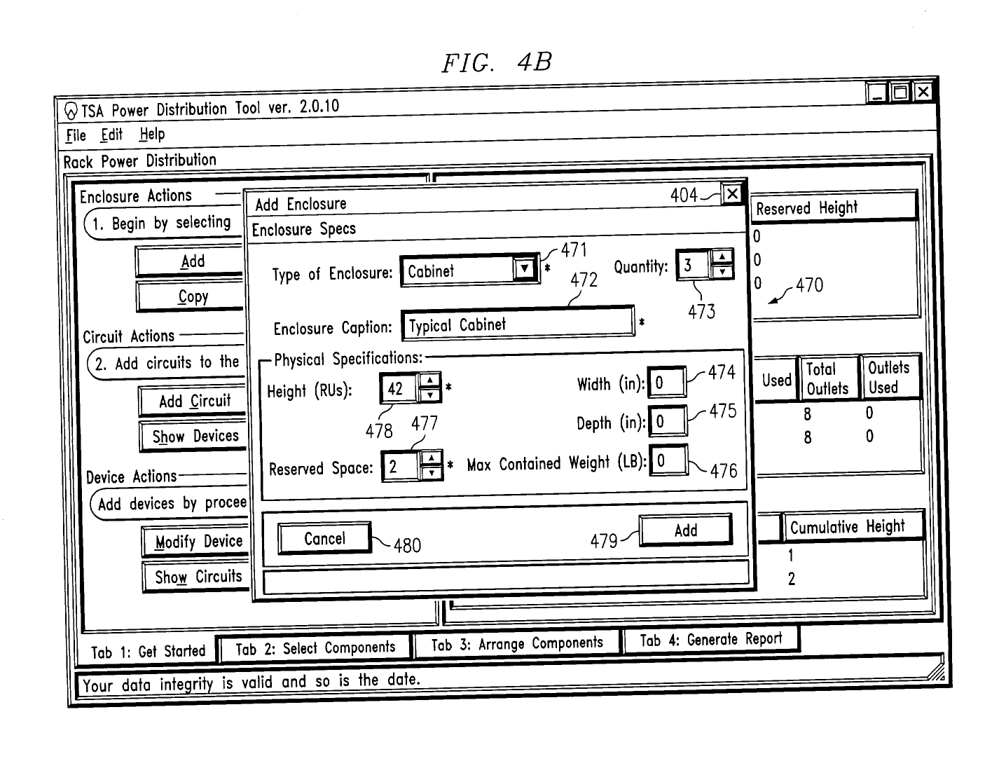

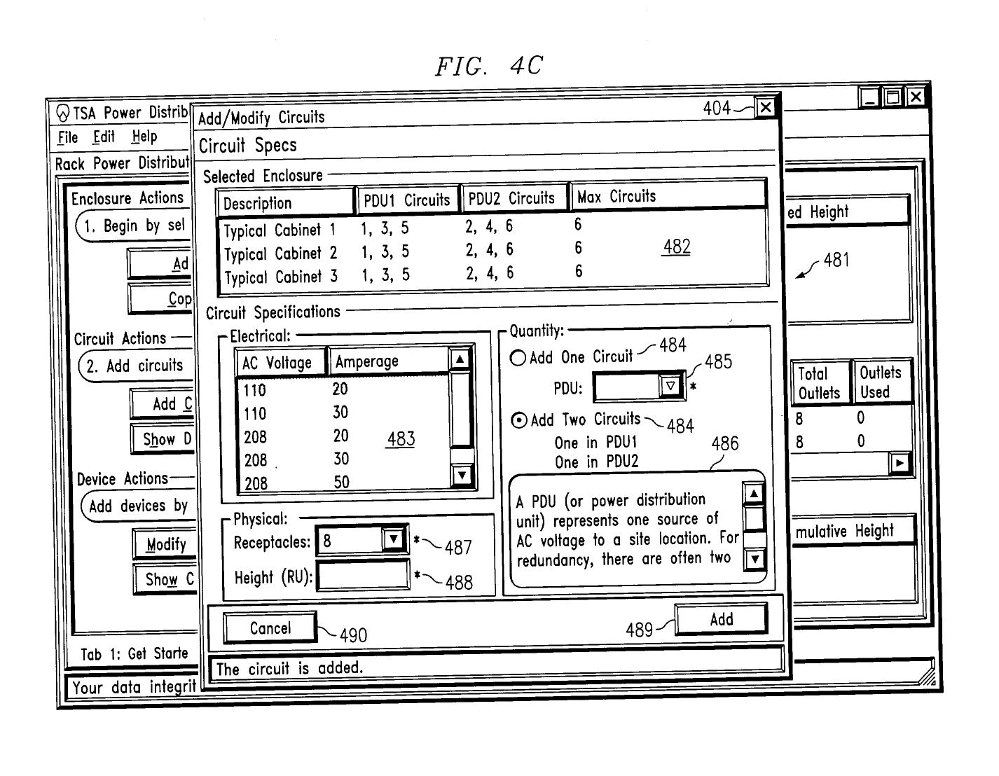

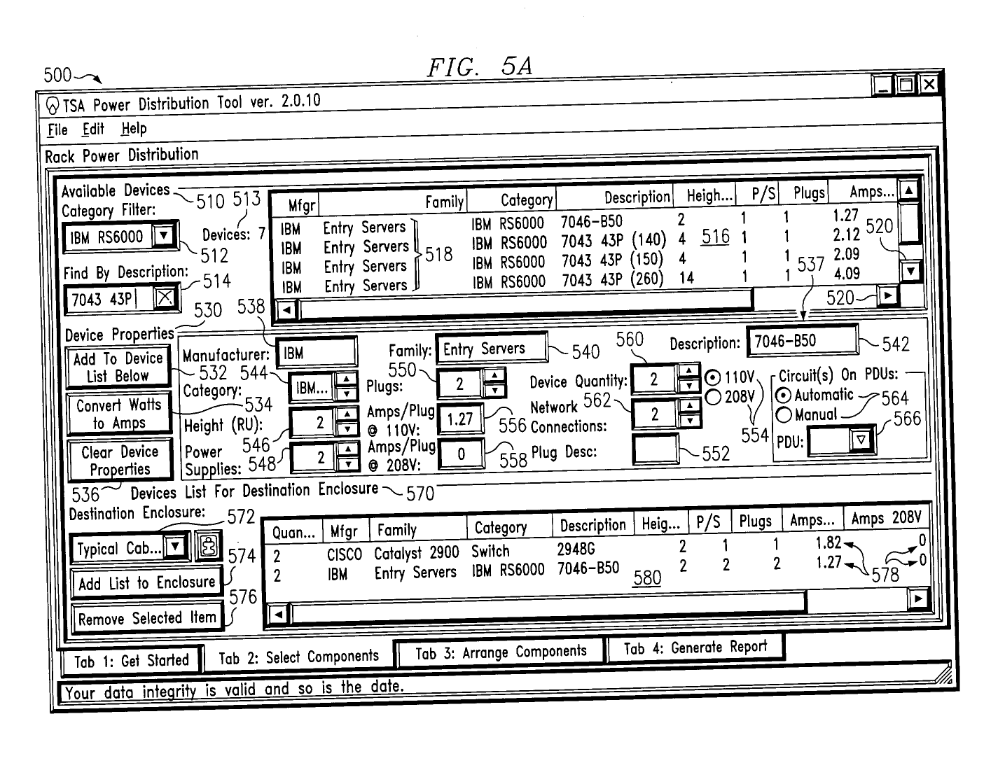

FIGS. 4A through 8A illustrate the main screens of Technical Solution Architect Power Distribution Program (TSAPDT) 900. Enclosure information screen 400 is a data entry screen in which the user enters general information about the enclosures and circuits. Component information screen 500 is a data entry screen in which the user enters specific information about the devices. Component arrangement screen 700 is an organizational screen in which the user can organize the devices in the various racks. Report screen 800 is a screen that displays a calculated report that informs the user of the location of each device and other useful information regarding configuration of the enclosure.

FIG. 4A is an illustration of enclosure information screen 400 of TSAPDT 900. There are several features of enclosure information screen 400 that are common to component information screen 500, component arrangement screen 700 and report screen 800. These common features are drop down menu 402, header bar 403, screen sizing buttons 404, information display 405, tab one 406, tab two 407, tab three 408, and tab four 409. Drop down menu 402 comprises “file,” “edit,” and “help” and allows the user to save, load, print, edit, or gain help with the file. Header bar 403 displays the title and the version number of TSAPDT 900. Screen sizing buttons 404 allow the user to minimize, maximize, or close TSAPDT 900. Information display 405 is an area where information regarding TSAPDT 900 can be displayed. Those of ordinary skill in the art will know best how to configure drop down menu 402, header bar 403, screen sizing buttons 404, and information display 405 as they are frequently found on other MICROSOFT WINDOWS and APPLE MACINTOSH based programs and applications. Tab one 406, tab two 407, tab three 408, and tab four 409 are screen index tabs and allow the user to quickly flip back and forth between enclosure information screen 400, component information screen 500, component arrangement screen 700, and report screen 800.

Enclosure information screen 400 is the screen where the user enters information regarding the enclosures and circuits. Enclosure information screen 400 is comprised of three sections: enclosure information section 410, circuit information section 430, and device information section 450. Enclosure information section 410 contains information about the enclosures at issue. Instructions 412 prompt the user to enter the enclosure information. The user may add a new enclosure by clicking add button 414, at which point a list of enclosures will appear (see FIG. 4B) and the user can select the type and quantity of enclosures desired.

FIG. 4B is an illustration of enclosure specification screen 470. The user selects the desired enclosure from enclosure pull down menu 471. Enclosure pull down menu 471 contains a list of numerous types of enclosures which are well known to persons skilled in the art. When the user selects a type of enclosure, a default enclosure caption will appear in enclosure caption field 472. The enclosure caption will be the name of the enclosure and appears on enclosure information screen 400, enclosure selection screen 470, circuit specification screen 481, component information screen 500, device specification screen 590, component arrangement screen 700, and report screen 800. If the user so desires, he or she may modify the enclosure caption to any other caption as appropriate. The user may also modify the number of enclosures desired in quantity field 473. When the user specifies the type of enclosure in enclosure pull down menu 471, in addition to the enclosure caption, TSAPDT 900 enters default specifications associated with the specific enclosure into height field 478, and reserved space field 477. The user may modify the height in height field 478 and the number of reserved spaces in reserved space field 477. The user also has the option of entering the width, depth, and maximum weight of the enclosure in width field 474, depth field 475, and weight field 476. The user may add the enclosure to enclosure display screen 424 when desired by clicking add button 479 or, in the alternative, may close enclosure selection screen 470 without adding the enclosure by clicking either cancel button 480 or the appropriate screen sizing button 404.

When the user has entered the appropriate information on enclosure specification screen 470, TSAPDT 900 will display enclosures 422 on enclosure display screen 424. the user may access enclosure specification screen 470 again by choosing the appropriate command form drop down menu 402, double clicking the desired enclosure, or right clicking the desired enclosure and choosing the edit function from the menu that appears. Enclosure display screen 424 also displays useful information about enclosures 422 such as the overall height of the enclosure, the height already used by devices in the enclosure, and any reserved height in the enclosures. The user may create additional enclosures similar to existing enclosures by highlighting the appropriate enclosure 422 on enclosure display screen 424 and clicking copy button 416. The user may remove enclosures by highlighting the appropriate enclosure 422 on enclosure display screen 424 and clicking remove button 420. The user may rename enclosures by highlighting the appropriate enclosure 422 on enclosure display screen 424 and clicking rename button 418. The user will then be prompted to enter the new name for the enclosure.

Circuit information section 430 contains information about the circuits connected to a specific enclosure 422 highlighted on enclosure display screen 424. Instructions 432 prompt the user to enter the circuit information for the specified enclosure. The user may add new circuits to the specified enclosure by clicking add circuit button 434, at which point a list of circuits will appear (see FIG. 4C) and the user can select the type and quantity of circuits desired.

FIG. 4C is an illustration of circuit specification screen 481. The enclosures are listed in enclosure screen 482. A list of different circuit types appears in circuit screen 483. The circuit list in circuit screen 483 is not exhaustive and should be modified as appropriate by persons skilled in the art. When the user selects a circuit type from circuit screen 483, the user can then choose the quantity of circuits to be added using quantity selector 484. If the user only desires one circuit, then he or she must specify which PDU the circuit is associated with on PDU pull down menu 485. It is common in the art to specify two circuits with each enclosure, one on each of two PDUs, so that a failure in one PDU or circuit will not result in a power loss to the devices. Therefore, if the user selects two circuits, TSAPDT 900 will place one on each PDU. The user may also specify the number of receptacles associated with the circuit on receptacle pull down menu 487, and the height of the circuit in height field 488. TSAPDT 900 will display any necessary comments in comment screen 486. The user may add the circuit to circuit display screen 442 when desired by clicking add button 489 or, in the alternative, may close circuit specification screen 481 without adding the circuit by clicking either cancel button 490 or the appropriate screen sizing button 404.

When the user has the appropriate information on the enclosure specification screen 481, TSAPDT 900 will display circuits 440 on circuit display screen 442. Circuit display screen 442 also displays useful information about circuits 440 such as the specified PDU, circuit voltage, total circuit amperage, amount of amperage used by devices, total outlets, and number of outlets used by devices. The user may remove circuits by highlighting the appropriate circuit 440 on circuit display screen 442 and clicking delete circuit button 438. The user may also display the devices associated only with circuit 440 highlighted on circuit display screen 442 by clicking show devices button 436. Devices 460 are then displayed on device display screen 462.

Device information section 450 contains information about the devices associated with a specific enclosure 422 highlighted in enclosure display screen 424. Instructions 452 prompt the user to enter device information on component information screen 500. Device display screen 462 displays useful information about devices 460 associated with enclosure 422 like the device height and the total height used in enclosure 422. The user may modify highlighted device 460 by clicking modify device button 454. The user is then presented with a screen that is similar to device properties section 530 on component information screen 500. The user may alter any of the information which was previously entered in component information screen 500. The user may remove devices by highlighting the appropriate device 460 on device display screen 462 and clicking delete device button 458. The user may also display the circuits associated only with device 460 highlighted on device display screen 462 by clicking show circuits button 456. Circuits 440 are then displayed on circuit display screen 442.

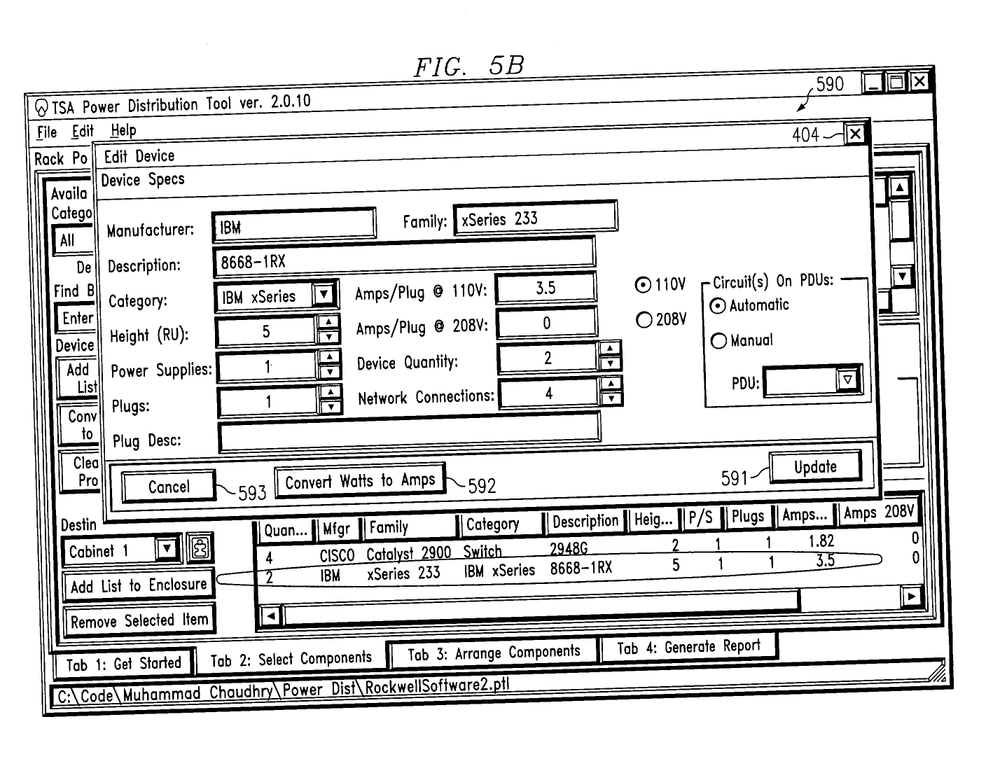

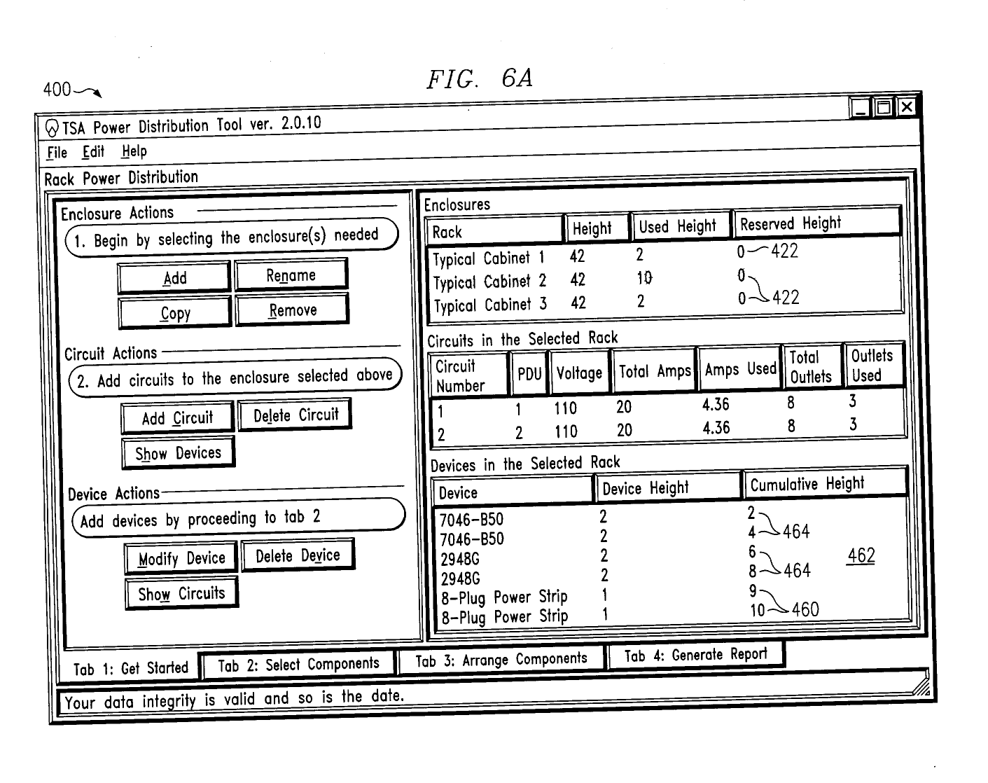

As seen in FIG. 5A, component information screen 500 is a data entry screen in which the user enters the information regarding the devices which are to be installed in the enclosures. Component information screen 500 is divided into three sections: available devices section 510, device properties section 530, and device list section 570. Available devices section 510 allows the user to select a device from the device database of TSAPDT 900. Device display screen 516 displays all of the available devices 518 in the device database and their properties. The user may use scroll bars 520 to browse through the list of devices 518 and their properties. If the user desires to limit the list of devices 518 on device display screen 516, he or she may do so by using filter pull-down menu 512. Filter pull-down menu 512 allows the user to select a specific category of device and view only the specified category of device on device display screen 516. TSAPDT 900 displays filter quantity 513 which shows the number of devices within the specific category selected in filter pull-down menu 512. If the user desires to find a specific device, the user may enter information into device search field 514 and TSAPDT 900 uses lexical parsing to display devices 518 which match the entered description.

Device properties section 530 contains all of the relevant information about a particular device. When device 518 is highlighted on device display screen 516, then manufacturer field 538, family field 540, description field 542, category field 544, height field 546, power supplies field 548, plugs field 550, plug description field 552, and network connections field 562 are automatically recalled from the TSAPDT 900 database and entered into the appropriate fields. Additionally, TSAPDT 900 database supplies the correct voltage on voltage selector 554 and the appropriate amperage in either 110V amperage field 556 or 208V amperage field 558. A default quantity of one is entered in quantity field 560, but the user may select other quantities as appropriate. The user may also specify which circuit a device is on by checking the appropriate circle on circuit on PDU selector 564. The default for circuit on PDU selector 564 is automatic, that is TSAPDT 900 automatically determines which circuit the device is on. However, if the user desires to specify a particular circuit for a particular device, then the user selects manual on circuit on PDU selector 564, and selects the appropriate circuit on PDU pull down menu 566. The user may convert any requirement which is disclosed in watts to amps by entering the appropriate wattage in either 110V amperage field 556 or 208V amperage field 558 and clicking conversion button 534. The user may also clear fields 538 through 566 by clicking clear device button 536. The user may add the selected device to the device list by clicking add device button 532. The user is allowed to modify any of fields 538 through 566 prior to adding the device to the enclosure.

Device list section 570 contains the relevant information about the devices which need to be added to the enclosures. Devices 578 which the user selected in device properties section 530 are displayed on device display screen 580. The user may add devices 578 to a specific enclosure by selecting the destination enclosure from the destination pull down menu 572 and clicking add list button 574. When the devices are added to the enclosure, TSAPDT 900 checks the power and space availability of the enclosure to ensure that the enclosure has sufficient space and power to accept the device. If the enclosure lacks the power for the device, TSAPDT 900 prompts the user to add more circuits to the enclosure. If the enclosure lacks sufficient space for the device or the circuit limit has been reached for an enclosure, TSAPDT 900 prompts the user to add the device to another enclosure. If none of the enclosures have sufficient space and/or power to accept the device, TSAPDT 900 prompts the user to add another enclosure. If the user desires to remove device 578 from device display screen 580, then the user may highlight the appropriate device 578 and click remove item button 576.

The user may also need to modify a device selection before the device is placed in an enclosure. To modify the device, the user highlights the device on device display screen 580 and either selects to edit the device from drop down menu 402, right clicks the device and selects edit from the menu that appears, or double clicks the device. When the user performs one of the previous three options, device specification screen 590 appears. FIG. 5B is an illustration of device specification screen 590. The user can then modify any of the properties of the device which were entered in component information screen 500. If required, the user may convert watts to amps using conversion button 592. The user may add the modifications to the device by clicking update button 591 or, in the alternative, may close device specification screen 590 without modifying the device by clicking either cancel button 593 or the appropriate screen sizing button 404.

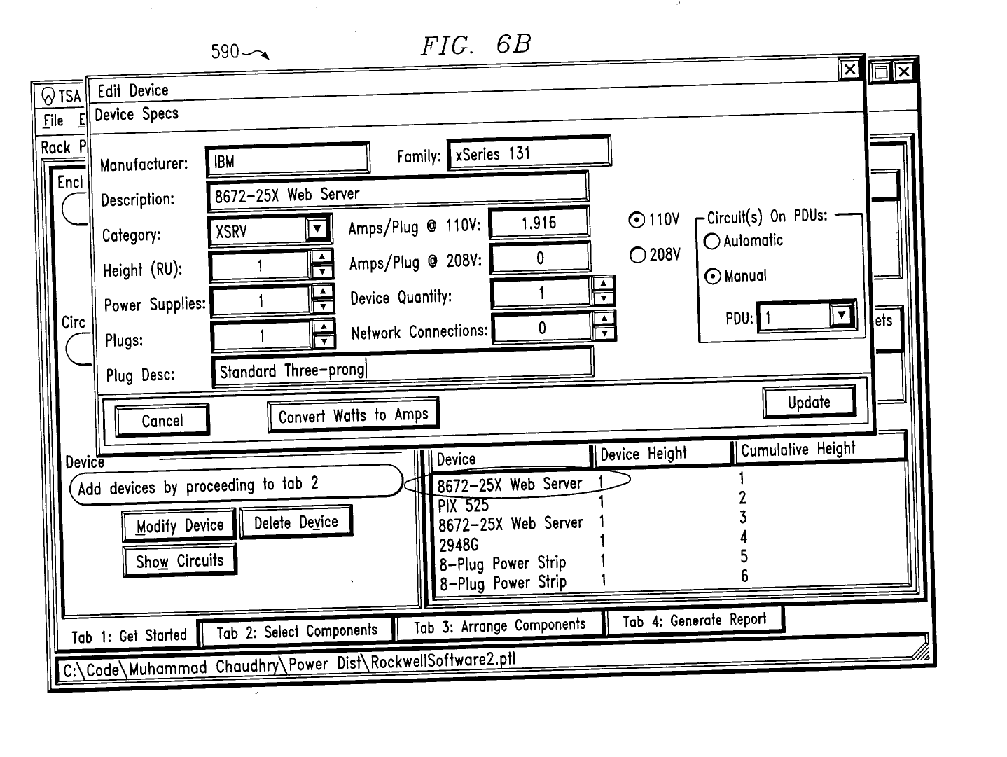

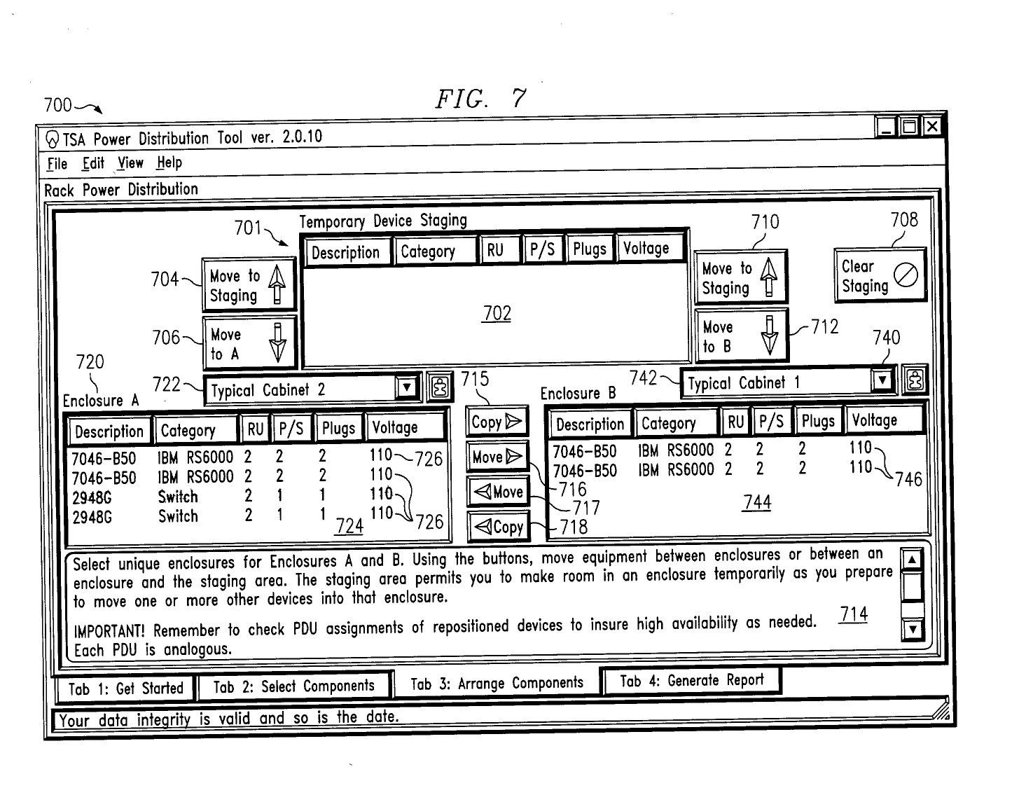

After the devices have been added to the enclosures in component information screen 500, the devices in the enclosures may be viewed on enclosure information screen 400. FIG. 6A shows enclosure information screen 400 with additional devices 464 added in component information screen 500 being displayed on device display screen 462. Devices 460 that are associated with the circuits are also displayed in device information screen 462. The information displayed in FIG. 6 shows a 42 RU high enclosure with two 20 amp, 110 Volt circuits with 4.36 amps used in each circuit, one power distribution unit for each circuit and four other devices installed in the cabinet. The user may also need to modify a device after the device has been located into an enclosure. To modify the device, the user highlights the device on device display screen 462 and either selects to edit the device from drop down menu 402, right clicks the device and selects edit from the menu that appears, or double clicks the device. When the user performs one of the previous three options, device specification screen 590 appears (see FIG. 6B). The user may then make the appropriate modifications in device specification screen 590.

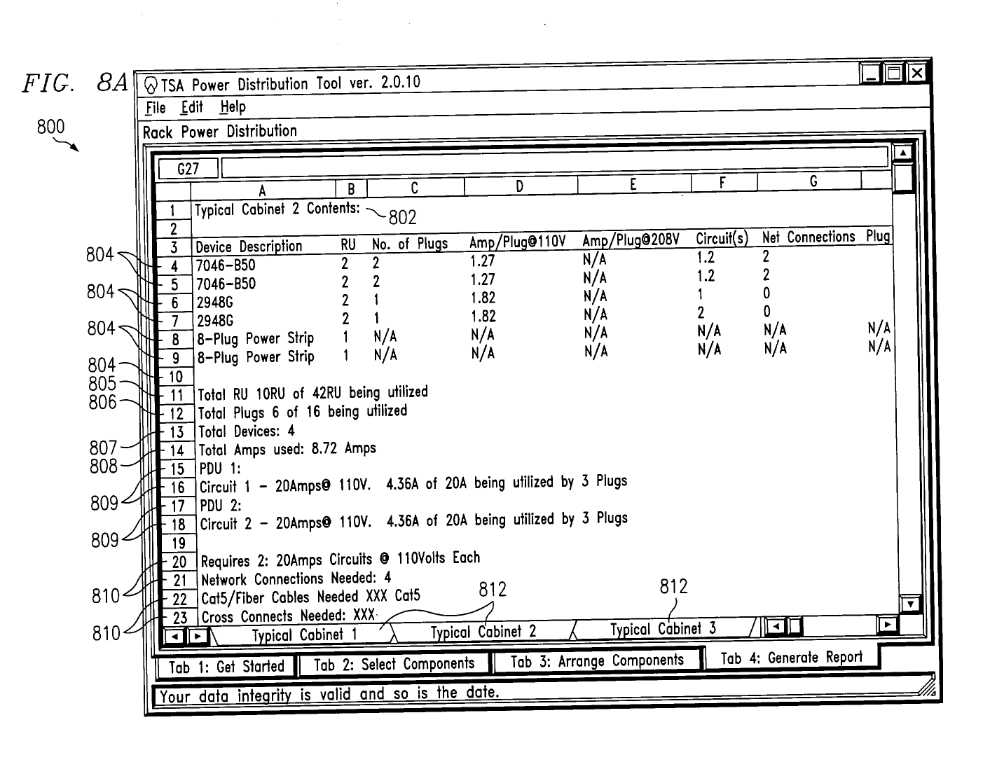

As seen in FIG. 7, component arrangement screen 700 is a screen in which the user can manipulate the devices within the enclosures. Component arrangement screen 700 is comprised of three sections: device staging section 701, enclosure A section 720, and enclosure B section 740. Initially, the user selects two enclosures to be designated enclosures A and B using enclosure A pull down menu 722 and enclosure B pull down menu 742. Devices 726 associated with enclosure A are displayed on enclosure A display screen 724. Devices 746 associated with enclosure B are displayed on enclosure B display screen 744. The user can copy the highlighted device 726 from enclosure A to enclosure B by clicking the copy button 715. The user can copy the highlighted device 746 from enclosure B to enclosure A by clicking the copy button 718. The user can move device 726 from enclosure A to enclosure B by clicking the move button 716. The user can move device 746 from enclosure B to enclosure A by clicking the move button 717. The user can move device 726 from enclosure A to temporary staging screen 702 by clicking the move button 704. The user can move device 746 from enclosure B to temporary staging screen 702 by clicking move button 710. The user can move a highlighted device (not shown) from temporary staging screen 702 to enclosure A by clicking the move button 706. The user can move a highlighted device (not shown) from temporary staging screen 702 to enclosure B by clicking move button 712. The user can delete all devices 746 on temporary staging screen 702 by clicking clear staging button 708. Instructions regarding component arrangement screen 700 and messages regarding the power and space requirements of the enclosures are displayed in information screen 714. TSAPDT 900 will not allow the enclosure to accept more devices than it can accommodate based on the space and power requirements. Therefore, device staging section 701 is necessary so that a device may be removed from one enclosure so that a device from the other enclosure may be placed in the first enclosure. All devices must be placed in an enclosure before TSAPDT 900 will allow the user to generate a report in report screen 800.

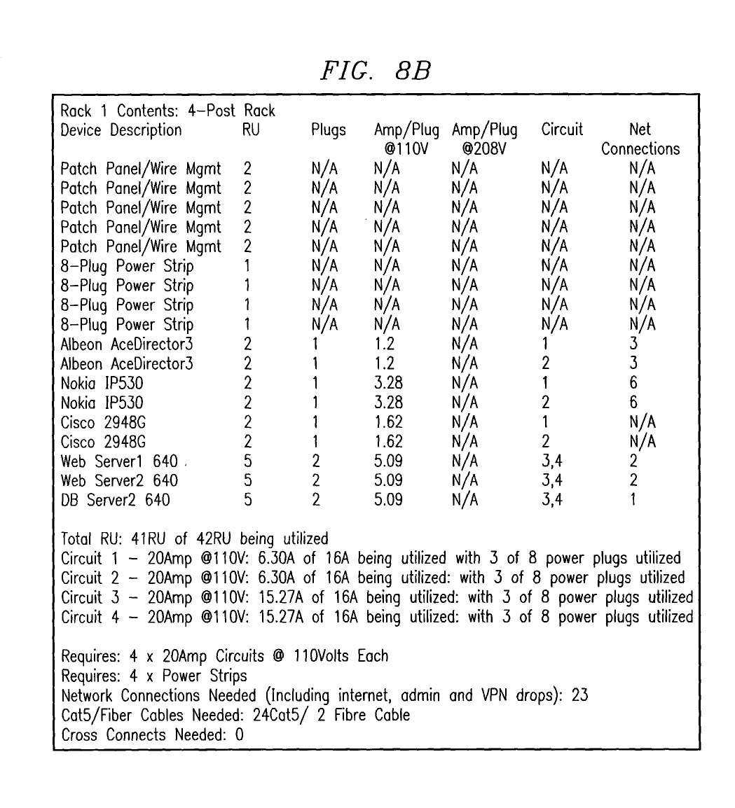

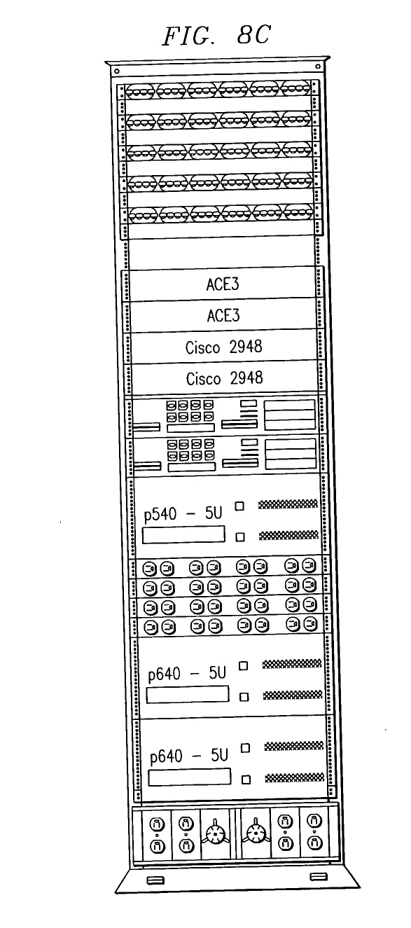

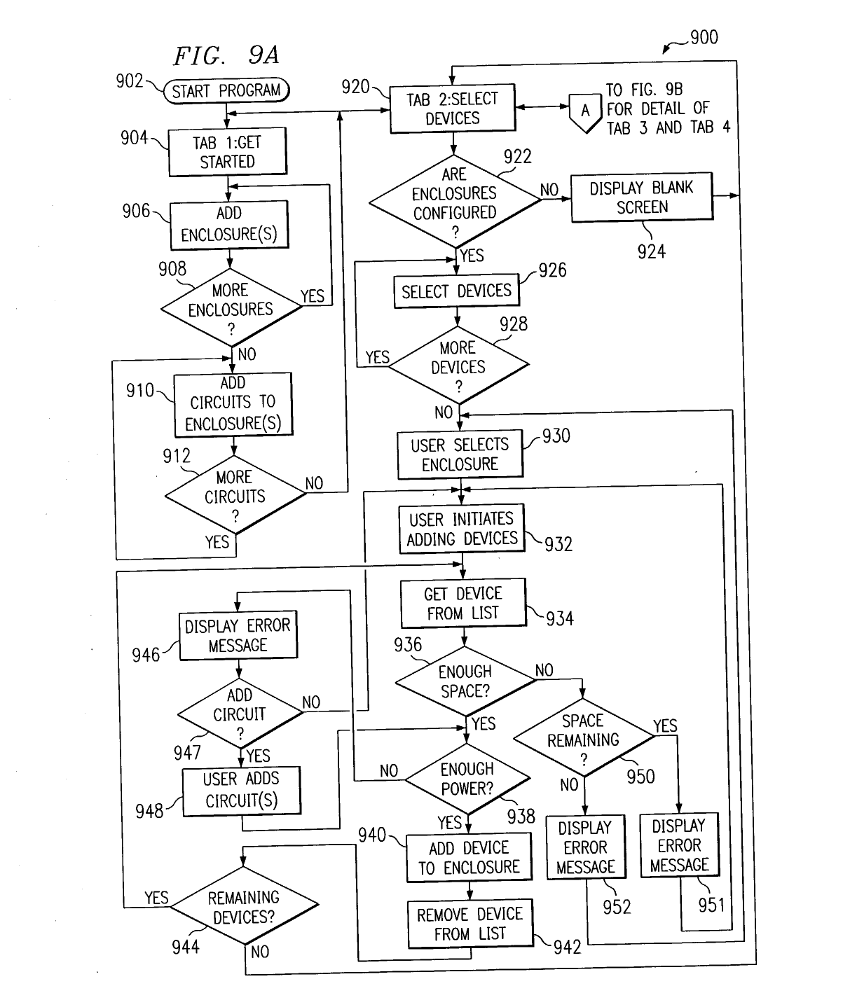

As seen in FIG. 8A, report screen 800 is the spreadsheet generated from the device reconfiguration in component arrangement screen 700. The spreadsheet in report screen 800 is in the MICROSOFT EXCEL format and can be cut and pasted into another report or a word processor document such as a MICROSOFT WORD document. The spreadsheet contains a tab 812 which is a spreadsheet which represents the enclosure. Each tab 812 contains enclosure title 802, devices 804 in the enclosure, the total spaced used in the enclosure 805, the total plugs 806 used in enclosure, the total number of devices 807, the total amps 808 used in the enclosure, the details of each PDU 809, and a summary of required parts 810 for the enclosure. FIG. 8B is an illustration of the report generated by TSAPDT 900 which contains numerous circuits and devices within a single enclosure. The technical solution architect uses the report in FIG. 8B to configure the actual physical enclosure with the specified devices and circuits. FIG. 8C is an illustration of an enclosure configured according to the report in FIG. 8B.

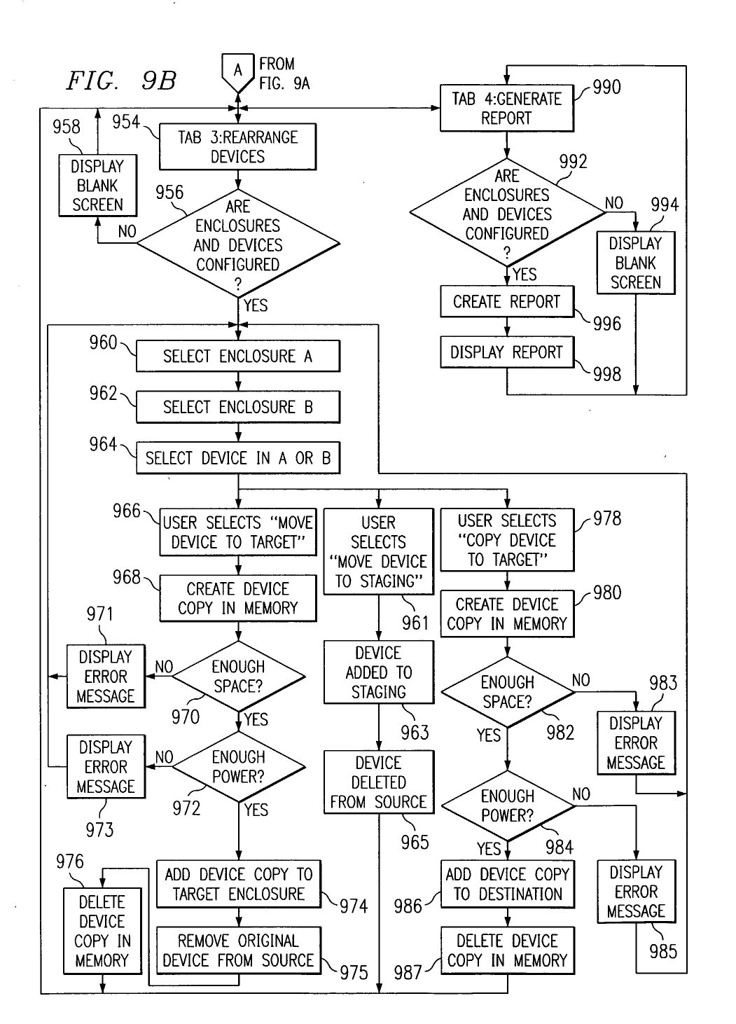

FIGS. 9A and 9B are a flowsheet of the logic behind TSAPDT 900. TSAPDT 900 starts (902) and displays the enclosure information screen to the user (904). The user is then prompted to add enclosures (906). The user is then queried whether he/she would like to add additional enclosures (908). If the user desires to add additional enclosures, TSAPDT 900 returns to step 906. If the user does not desire to add any additional enclosures, TSAPDT 900 prompts the user to add the circuits (910). The user is then queried whether he/she would like to add additional circuits (912). If the user desires to add additional circuits, TSAPDT 900 returns to step 910. If the user does not desire to add any more circuits, then TSAPDT 900 returns to step 904.

While at step 904, the user has the option of viewing component information screen 500 (920), component information screen 700 (954), or report screen 800 (990). If the user selects to view component information screen 500 (920), TSAPDT 900 makes a determination whether the enclosures are configured (922). If the user has added at least one enclosure at step 906, then the enclosures are configured. If the enclosures are not configured, then TSAPDT 900 displays a blank screen (924) and returns to step 902. If the enclosures are configured, then the user is prompted to select devices to add to the enclosure (926). The user is then queried to whether he/she would like to add more devices (928). If the user desires to add more devices, TSAPDT 900 returns to step 926. If the user does not desire to add any more devices, then TSAPDT 900 prompts the user to select the enclosures for the devices (930). The user then selects a device to add to the enclosure (932), and TSAPDT 900 acquires the device from the list of devices (934). TSAPDT 900 then makes a determination whether there is sufficient space for the device in the enclosure (936). If sufficient space does not exist, TSAPDT 900 makes a determination whether any space remains in the enclosure (950). If space remains in the enclosure but is insufficient to accommodate the device, TSAPDT 900 displays an error message informing the user that space remains in the enclosure but the device will not fit in the enclosure (951) and returns to step 932. If at step 950, TSAPDT 900 determines that no space remains in the enclosure, TSAPDT 900 displays an error message informing the user that the enclosure is full (952) and returns to step 930. If at step 936, TSAPDT 900 determines that there is sufficient space in the enclosure, TSAPDT 900 makes a determination if there is sufficient power within the enclosure to accommodate the device (938). If the enclosure lacks sufficient power to accommodate the device, TSAPDT 900 displays a message that insufficient power exists (946) and queries the user whether he/she would like to add another circuit (947). If the user desires to add another circuit, then TSAPDT 900 allows the user to add the circuit (948) and returns to step 938. If the user does not want to add another circuit, TSAPDT 900 returns to step 932. If at step 938, sufficient power exists to accommodate the device, TSAPDT 900 adds the device to the enclosure (940) and removes the device from the device list (942). TSAPDT 900 then makes a determination whether there are any remaining devices (944). If devices remain, then TSAPDT 900 returns to step 934. If no devices remain, then TSAPDT 900 returns to step 920.

If the user selects to view component arrangement screen 700 (954), then TSAPDT 900 makes a determination whether the enclosures and devices have been configured (956). If the enclosures are not configured or the devices have not been configured, then TSAPDT 900 displays a blank screen (958) and returns to step 954. If the enclosures and devices are configured, then TSAPDT 900 prompts the user to select an enclosure which will be referred to as enclosure A (960). TSAPDT 900 then prompts the user to select an enclosure which will be referred to as enclosure B (962). TSAPDT 900 then prompts the user to select a device in either enclosure A or enclosure B (964). The user then has the option of selecting to move the device from the source enclosure to the target enclosure (966), copying the device from the source enclosure to the target enclosure (978), or moving the device from the source enclosure to the staging area (961). If the user desires to move a device from the source enclosure to the target enclosure, the user highlights the device in the source enclosure and clicks either move button 706, move button 712, move button 716, or move button 717 (966). TSAPDT 900 then creates a temporary copy of the device in the memory (968). TSAPDT 900 then makes a determination whether the target enclosure has sufficient space to accommodate the device (970). If the target enclosure lacks sufficient space, then TSAPDT 900 displays a message indicating the target enclosure has insufficient space (971) and returns to step 960. If the target enclosure has sufficient space, then TSAPDT 900 makes a determination whether the target enclosure has sufficient power to accommodate the device (972). If the target enclosure lacks sufficient power to accommodate the device, then TSAPDT 900 displays a message indicating that the target enclosure lacks sufficient power (973) and returns to step 960. If the target enclosure has sufficient power available, TSAPDT 900 adds the device to the target enclosure (974) removes the device from the source enclosure (975), deletes the device copy in memory (976), and returns to step 954.

If after step 964, the user desires to copy a device from a source enclosure to a target enclosure, the user highlights the device in the source enclosure and clicks either copy button 715 or copy button 718 (978). TSAPDT 900 then creates a temporary copy of the device in the memory (980). TSAPDT 900 then makes a determination whether the target enclosure has sufficient space to accommodate the device (982). If the target enclosure lacks sufficient space, then TSAPDT 900 displays a message indicating the target enclosure has insufficient space (983) and returns to step 960. If the target enclosure has sufficient space, then TSAPDT 900 makes a determination whether the target enclosure has sufficient power to accommodate the device (984). If the target enclosure lacks sufficient power to accommodate the device, then TSAPDT 900 displays a message indicating that the target enclosure lacks sufficient power (985) and returns to step 960. If the target enclosure has sufficient power available, TSAPDT 900 adds the device to the target enclosure (986), deletes the device copy in memory (987), and returns to step 954.

If after step 964, the user desires to move a device from a source enclosure to staging area, the user highlights the device in the source enclosure and clicks either move button 704 or move button 710 (961). TSAPDT 900 then adds the device to the staging area (963), deletes the device from the source enclosure (965), and returns to step 954.

If the user selects to view report screen 800 (990), then TSAPDT 900 makes a determination whether the enclosures have been configured (992). If the enclosures are not configured, then TSAPDT 900 displays a blank screen (994) and returns to step 954. If the enclosures are configured, then TSAPDT 900 creates a report of all of the enclosures and the devices and circuits associated with the enclosure (996). TSAPDT 900 then displays the report (998) and returns to step 990.

Several alternative embodiments are available which encompass the spirit of the present invention. For example, one alternative embodiment is to add a module which will enable TSAPDT 900 to determine the most effective arrangement of devices within a plurality of enclosures. In determining the most effective arrangement, TSAPDT 900 can rank the devices in order of their space requirements, power requirements, or a combination of space and power requirements. TSAPDT 900 could then process the list of devices starting with the most demanding and automatically place each device within the first enclosure that can accommodate the device. TSAPDT 900 could then seek better enclosure configurations by assigning a percentage filled value to the space and power available in each enclosure. TSAPDT 900 could then test alternative arrangements of devices by examining the possibility of switching two devices in two separate enclosures. If the switching of devices would result in a more effective use of space or power in one or both of the enclosures, then TSAPDT 900 could permanently switch the two devices. TSAPDT 900 could examine the possibility of switching all of the devices within the various enclosures until TSAPDT 900 determines what the most effective arrangement of devices in the enclosures is.

Similarly, another alternative embodiment of TSAPDT 900 is to have the user specify the devices and types of enclosures and allow TSAPDT 900 to determine the arrangement of devices within the enclosures and the number enclosures that are required, the number and type of circuits that are required, and the arrangement of devices within the enclosures.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A method comprising:
specifying a plurality of enclosures;
specifying a plurality of devices; and
arranging said devices within said enclosures.

2. The method of claim 1 further comprising generating a report specifying the configuration of said devices within said enclosures.

3. The method of claim 1 further comprising:
determining if said enclosures can accommodate the power requirement of said devices;
determining if said enclosures can accommodate the space requirement of said devices; and
rearranging said devices within said enclosures.

4. The method of claim 1 further comprising:
ranking said devices by the power requirement of said device; and
wherein said devices are arranged in the order in which said devices are ranked.

5. The method of claim 1 further comprising:
ranking said devices by the space requirement of said device; and
wherein said devices are arranged in the order in which said devices are ranked.

6. The method of claim 1 further comprising specifying at least one circuit within each of said enclosures.

7. The method of claim 6 further comprising determining if said circuit can accommodate the power requirement of said devices.

8. The method of claim 1 further comprising constructing said enclosure according to said report.

9. A method for determining the arrangement of a plurality of devices in at least one enclosure comprising:
specifying a power requirement and a space requirement for each of said devices;
determining if said enclosure can accommodate the power requirement of said device;
determining if said enclosure can accommodate the space requirement of said device; and
arranging said devices within said enclosure.

10. The method of claim 9 further comprising generating a report specifying the configuration of said devices within said enclosures.

11. The method of claim 9 further comprising:
ranking said devices by the power requirement of said device; and
wherein said devices are arranged in the order in which said devices are ranked.

12. The method of claim 9 further comprising:
ranking said devices by the space requirement of said device; and
wherein said devices are arranged in the order in which said devices are ranked.

13. The method of claim 9 further comprising specifying at least one circuit within each of said enclosures.

14. The method of claim 13 further comprising determining if said circuit can accommodate the power requirement of said devices.

15. The method of claim 9 further comprising constructing said enclosure according to said report.

16. A method for determining the configuration of at least one enclosure comprising:
specifying a plurality of devices;
arranging said devices within said enclosure; and
generating a report specifying the configuration of said devices within said enclosure.

17. The method of claim 16 further comprising:
determining if said enclosures can accommodate the power requirement of said devices; and
determining if said enclosures can accommodate the space requirement of said devices.

18. The method of claim 16 further comprising:
ranking said devices by the power requirement of said device; and
wherein said devices are arranged in the order in which said devices are ranked.

19. The method of claim 16 further comprising:
ranking said devices by the space requirement of said device; and
wherein said devices are arranged in the order in which said devices are ranked.

20. The method of claim 16 further comprising specifying at least one circuit within each of said enclosures.

21. The method of claim 20 further comprising determining if said circuit can accommodate the power requirement of said devices.

22. The method of claim 16 further comprising constructing said enclosure according to said report.

23. A programmable computer apparatus comprising:
hardware;
software; and
wherein said hardware is directed by said software to perform steps comprising:
instructions for specifying a plurality of enclosures;
instructions for specifying a plurality of devices; and
instructions for arranging said devices within said enclosures.

24. The apparatus of claim 23 further comprising instructions for generating a report specifying the configuration of said devices within said enclosures.

25. The apparatus of claim 23 further comprising:
instructions for determining if said enclosures can accommodate the power requirement of said devices;
instructions for determining if said enclosures can accommodate the space requirement of said devices; and
instructions for rearranging said devices within said enclosures.

26. The apparatus of claim 23 further comprising:
instructions for ranking said devices by the power requirement of said device; and
wherein said devices are arranged in the order in which said devices are ranked.

27. The apparatus of claim 23 further comprising:
instructions for ranking said devices by the space requirement of said device; and
wherein said devices are arranged in the order in which said devices are ranked.

28. The apparatus of claim 23 further comprising instructions for specifying at least one circuit within each of said enclosures.

29. The apparatus of claim 28 further comprising instructions for determining if said circuit can accommodate the power requirement of said devices.

30. The apparatus of claim 23 further comprising instructions for constructing said enclosure according to said report.

31. A programmable computer apparatus comprising:
hardware;
software; and
wherein said hardware is directed by said software to perform steps comprising:
specifying a power requirement and a space requirement for each of said devices;
determining if said enclosure can accommodate the power requirement of said device;
determining if said enclosure can accommodate the space requirement of said device; and
arranging said devices within said enclosure.

32. The apparatus of claim 31 further comprising instructions for generating a report specifying the configuration of said devices within said enclosures.

33. The apparatus of claim 31 further comprising:
instructions for ranking said devices by the power requirement of said device; and
wherein said devices are arranged in the order in which said devices are ranked.

34. The apparatus of claim 31 further comprising:
instructions for ranking said devices by the space requirement of said device; and
wherein said devices are arranged in the order in which said devices are ranked.

35. The apparatus of claim 31 further comprising instructions for specifying at least one circuit within each of said enclosures.

36. The apparatus of claim 35 further comprising instructions for determining if said circuit can accommodate the power requirement of said devices.

37. The apparatus of claim 31 further comprising instructions for constructing said enclosure according to said report.

38. A programmable computer apparatus comprising:
hardware;
software; and
wherein said hardware is directed by said software to perform steps comprising:
specifying a plurality of devices;
arranging said devices within said enclosure; and
generating a report specifying the configuration of said devices within said enclosure.

39. The apparatus of claim 38 further comprising:
instructions for determining if said enclosures can accommodate the power requirement of said devices; and
instructions for determining if said enclosures can accommodate the space requirement of said devices.

40. The apparatus of claim 38 further comprising:
instructions for ranking said devices by the power requirement of said device; and
wherein said devices are arranged in the order in which said devices are ranked.

41. The apparatus of claim 38 further comprising:
instructions for ranking said devices by the space requirement of said device; and
wherein said devices are arranged in the order in which said devices are ranked.

42. The apparatus of claim 3 8 further comprising instructions for specifying at least one circuit within each of said enclosures.

43. The apparatus of claim 42 further comprising instructions for determining if said circuit can accommodate the power requirement of said devices.

44. The apparatus of claim 38 further comprising instructions for constructing said enclosure according to said report.

45. An apparatus comprising:
means for specifying a plurality of enclosures;
means for specifying a plurality of devices; and
means for arranging said devices within said enclosures.

46. The apparatus of claim 45 further comprising means for generating a report specifying the configuration of said devices within said enclosures.

47. The apparatus of claim 45 further comprising:
means for determining if said enclosures can accommodate the power requirement of said devices;
means for determining if said enclosures can accommodate the space requirement of said devices; and
means for rearranging said devices within said enclosures.

48. The apparatus of claim 45 further comprising:
means for ranking said devices by the power requirement of said device; and
wherein said devices are arranged in the order in which said devices are ranked.

49. The apparatus of claim 45 further comprising:
means for ranking said devices by the space requirement of said device; and
wherein said devices are arranged in the order in which said devices are ranked.

50. The apparatus of claim 45 further comprising means for specifying at least one circuit within each of said enclosures.

51. The apparatus of claim 50 further comprising means for determining if said circuit can accommodate the power requirement of said devices.

52. The apparatus of claim 45 further comprising means for constructing said enclosure according to said report.
